(19) United States
(12) Patent Application Publication
(10) Pub. No.: US 2025/0237996 A1
(43) Pub. Date: Jul. 24, 2025

(54) Watch Part, Watch, And Method For Producing Watch Part

(71) Applicant: SEIKO EPSON CORPORATION, Tokyo (JP)

(72) Inventor: Seisho SAKODA, Shiojiri (JP)

(21) Appl. No.: 19/027,739

(22) Filed: Jan. 17, 2025

(30) Foreign Application Priority Data
Jan. 18, 2024 (JP) 2024-006237

(51) Int. Cl. G04B 19/12; G04B 45/00; G04D 3/00

(52) U.S. Cl. CPC G04B 19/12; G04B 45/0076; G04D 3/0074

(57) ABSTRACT

A watch part includes a base, a first layer formed by applying a decorative material to a surface of the base, a second layer formed by applying a first resin material having light-transmitting properties to a surface of the first layer, and a third layer formed by performing ink jet printing using a metal nano-ink containing metal nanoparticles on a surface of the second layer.

The present application is based on, and claims priority from JP Application Serial Number 2024-006237, filed Jan. 18, 2024, the disclosure of which is hereby incorporated by reference herein in its entirety.

### BACKGROUND

### 1. Technical Field

The present disclosure relates to a watch part, a watch, and a method for producing a watch.

### 2. Related Art

JP-A-2000-111660 discloses a dial including a plated metal plate that has characters and images formed by ink jet printing. In JP-A-2000-111660, formation of a transparent ink receptive layer on a surface of the plated metal plate eliminates the need for production of a film and a printing plate, enabling a short time, low-cost, and high-mix low-volume production of dials.

In JP-A-2000-111660, characters and images are merely formed by ink jet printing, and thus it is difficult to express luxurious design. To solve the problem, the inventor of the present disclosure tried to express luxurious design by coating a surface of a base with a colored paint containing a pigment and performing ink jet printing using a metal nano-ink containing metal nanoparticles on the colored paint. However, the metal nano-ink applied to the colored paint causes a new problem: discoloration of the metal nano-ink.

### SUMMARY

According to an aspect of the present disclosure, a watch part includes a base, a first layer formed by applying a decorative material to a surface of the base, a second layer formed by applying a first resin material having light-transmitting properties to a surface of the first layer, and a third layer formed by performing ink jet printing using a metal nano-ink containing metal nanoparticles on a surface of the second layer.

According to an aspect of the present disclosure, a watch includes the watch part.

According to an aspect of the present disclosure, a method for producing a watch part includes: applying a decorative material to a surface of a base to form a first layer; applying a first resin material having light-transmitting properties to a surface of the first layer to form a second layer; performing ink jet printing using a metal nano-ink containing metal nanoparticles on a surface of the second layer to form a third layer.

### BRIEF DESCRIPTION OF THE DRAWINGS

FIG. 1 is a front view illustrating a watch according to a first embodiment.

FIG. 2 is a cross-sectional view illustrating a main portion of a dial of the first embodiment.

FIG. 3 is a view illustrating layers of the dial of the first embodiment.

FIG. 4 is a cross-sectional view illustrating a main portion of a dial of a second embodiment.

FIG. 5 is a view illustrating layers of the dial of the second embodiment.

### DESCRIPTION OF EMBODIMENTS

### Fifth Embodiment

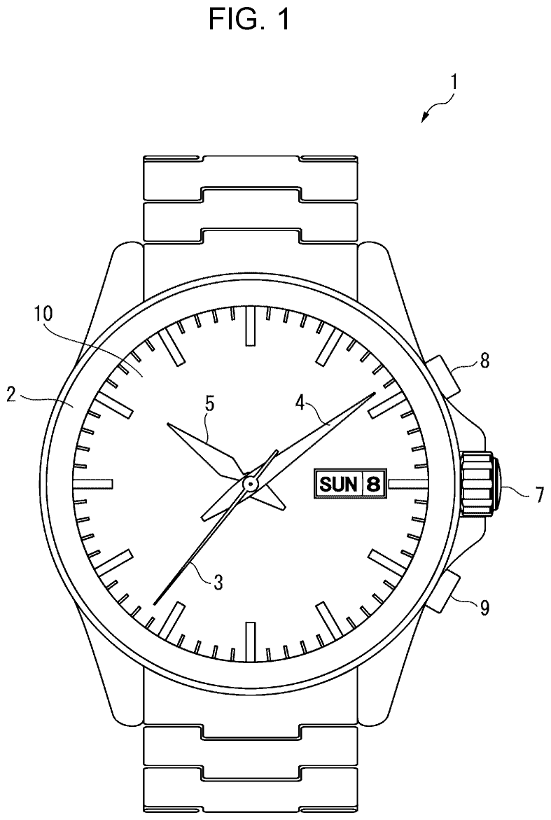

Hereinafter, a watch 1 according to a first embodiment of the present disclosure will be described with reference to the drawings. FIG. 1 is a front view of the watch 1. In this embodiment, the watch 1 is a wristwatch worn on the user's wrist. As illustrated in FIG. 1, the watch 1 includes a metal case 2. The case 2 houses a disc-shaped dial 10, a seconds hand 3, a minute hand 4, an hour hand 5, a crown 7, an A button 8, and a B button 9. The dial 10 is an example of a watch part of the present disclosure.

### Dial

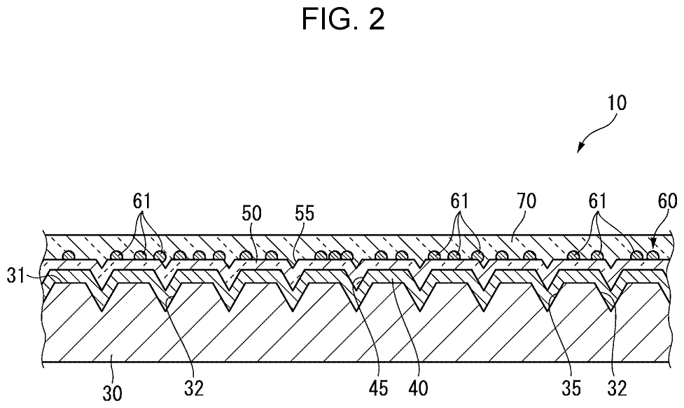

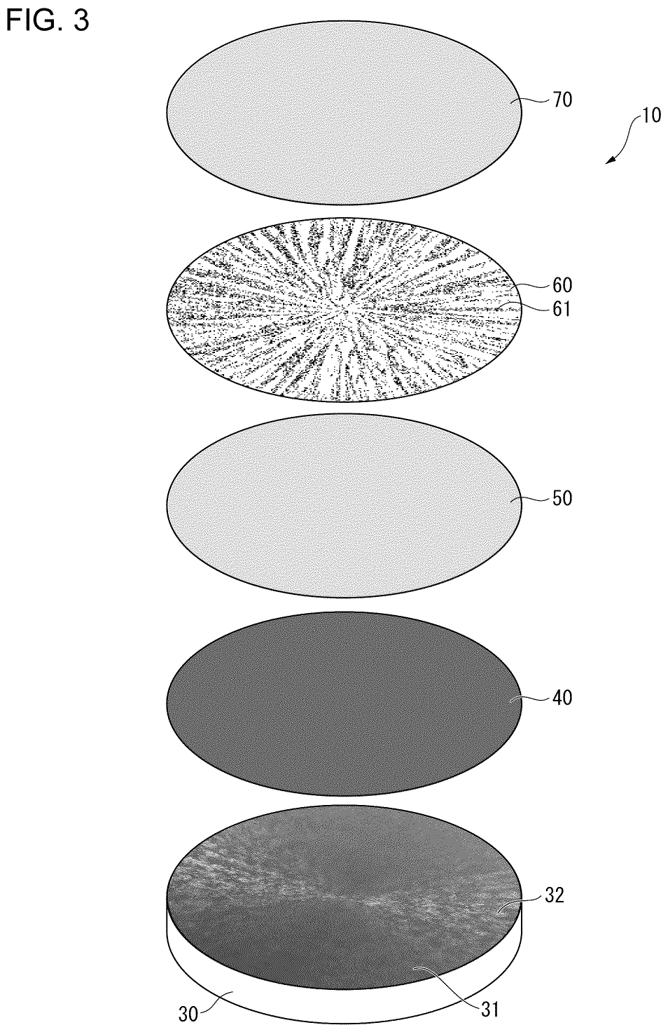

FIG. 2 is a cross-sectional view of the dial 10 taken in the thickness direction, and FIG. 3 is an exploded perspective view showing layers of the dial 10 separated from each other. In this embodiment, the surface of the dial 10 means the surface adjacent to the cover glass of the watch 1 in the thickness direction of the dial 10, i.e., the surface of the dial 10 to be seen. The surface of each layer is also the surface adjacent to the cover glass of the watch 1. As illustrated in FIG. 2, the dial 10 includes a base 30. The base 30 is formed of one of shell, resin, and metal or a combination of these. Thus, the base 30 can have the texture of these materials. For example, the base 30 may be formed by carving out mother of pearl to express design having color tone that changes with the changing light. Furthermore, the base 30 may be formed of a precious metal such as platinum to have a luxurious look. The base 30 may be subjected to a predetermined surface treatment. For example, when the base 30 is formed of brass, the base 30 may be subjected to a surface treatment for rust prevention such as nickel plating.

The base 30 has multiple recesses 32 on the surface 31. More specifically, the surface 31 of the base 30 is striated to form the recesses 32 extending radially from the center. Thus, in this embodiment, the surface 31 of the base 30 has a bumpy pattern 35 due to the formation of the recesses 32. The thickness of the base 30 is, for example, about 0.25 mm to about 0.50 mm. The depth of the recess 32 is several tens of micrometers to about 100 μm. Since a typical mold used for stamping on the surface of the dial 10 has protrusions and recesses having a height of about 50 μm to about 60 μm, the recesses 32 can be formed, for example, by stamping using a mold.

The base 30 has a first layer 40 formed by applying a decorative material to the surface 31. The decorative material is, for example, a colored paint containing a pigment, and the colored paint is applied or vapor-deposited on the surface 31 to form the first layer 40. The first layer 40 has a thickness of 1 μm to 100 μm, typically about 10 μm to about 30 μm, for example, when formed by coating with the colored paint. The first layer 40 has a thickness of, for example, about 0.3 μm to about 1.0 μm, when formed by vapor deposition. If the thickness of the first layer 40 is less than the depth of the recess 32, as illustrated in FIG. 2, the first layer 40 applied to the surface 31 of the base 30 also has a bumpy pattern 45 corresponding to the recesses 32.

The first layer 40 has a second layer 50 formed by applying a first resin material having light-transmitting properties to a surface of the first layer 40. The first resin material may be any resin material that can transmit light, such as transparent or translucent resin. Examples of the resin include acrylic resin, urethane resin, polyethylene resin, and polyester resin. In this embodiment, the first resin material is acrylic resin. The second layer 50 has a thickness of, for example, 1 μm to 100 μm, typically about 10 μm to about 30 μm. If the thickness of the second layer 50 is less than the depth of the recess of the bumpy pattern 45, as illustrated in FIG. 2, the second layer 50 applied to the surface of the first layer 40 also has a bumpy pattern 55 corresponding to the bumpy pattern 45.

The second layer 50 has a third layer 60 formed by performing ink jet printing using a metal nano-ink containing metal nanoparticles on a surface of the second layer 50. The third layer 60 is composed of dots 61 formed of a metal nano-ink landed on the surface of the second layer 50 along a predetermined printing pattern. This forms a predetermined pattern of dots 61 on the surface of the second layer 50, resulting in printing of a predetermined pattern on the surface of the second layer 50. For example, a radial pattern can be printed by formation of dots 61 arranged radially from the center of the dial 10 in a plane. The surface of the second layer 50 is the surface of the second layer 50 exposed to the watch face side and includes protrusions and recesses of the bumpy pattern 45. Thus, the dots 61 may be formed not only on the protrusions but also in the recesses of the bumpy pattern 45.

Here, a metal nano-ink is a composition including a dispersant and metal nanoparticles dispersed in the dispersant. The metal nanoparticles are metal particles having a particle diameter of 1 nm or more and 1 μm or less and preferably include one of gold, silver, copper, and platinum. This enables printing using a metal nano-ink to provide a glossy pattern, and thus more luxurious design can be expressed. In this embodiment, the dots 61 have a thickness of about 2 μm to about 5 μm and a dot diameter (diameter) of about 15 μm to about 30 μm.

The third layer 60 has a fourth layer 70 formed by applying a second resin material having light-transmitting properties to a surface of the third layer 60. Like the first resin material, the second resin material may be any resin material that can transmit light, such as transparent resin and translucent resin. Examples of the second resin material include acrylic resin, polyethylene resin, and polyester resin. In this embodiment, the second resin material is the same material as the first resin material, i.e., acrylic resin. The first resin material and the second resin material may be composed of different resin materials. The fourth layer 70 has a thickness of, for example, 1 μm to 100 μm, and may have any thickness that is enough to cover the dots 61.

### Method for Producing Dial

Next, steps for producing the dial 10 will be described with reference to FIG. 3. As illustrated in FIG. 3, a formation step is first performed in which the recesses 32 are formed on the surface 31 of the base 30 to form the bumpy pattern 35. Specific examples of the method for forming the bumpy pattern 35 include stamping, laser processing, cutting, chemical removal, polishing, and forging and casting, and an appropriate method can be used depending on the material of the base 30 and the bumpy pattern 35.

Next, a first step is performed in which a colored paint, which is a decorative material, is applied to the surface 31 of the base 30 to form the first layer 40. The method for applying the colored paint is not particularly limited, and examples of the method include coating methods such as spin coating, dipping, brush coating, spray coating, electrostatic coating, and electrodeposition coating.

Next, a second step is performed in which a first resin material having light-transmitting properties is applied to a surface of the first layer 40 to form the second layer 50. The method for applying the first resin material is not particularly limited like the coating method with the colored paint, and an appropriate method such as spin coating can be selected. Next, a third step is performed in which ink jet printing using a metal nano-ink is performed on a surface of the second layer 50 based on a prepared printing pattern to form the third layer 60. Next, a fourth step is performed in which a second resin material having light-transmitting properties is applied to a surface of the third layer 60 to form the fourth layer 70. The method for applying the second resin material is not particularly limited like the method for applying the first resin material, and an appropriate method such as spin coating can be selected. Furthermore, if necessary, a lapping step may be performed to polish and smooth the surface of the fourth layer 70 after the fourth step. This process is a finishing step in which the fourth layer 70 is polished, further improving design.

### Advantages of First Embodiment

The above-described first embodiment can achieve the following advantages. The dial 10, which is a watch part of the first embodiment, includes, in this order, the first layer 40 formed of a decorative material on a surface of the base 30, the second layer 50 formed of the first resin material having light-transmitting properties, and the third layer 60 having the dots 61 formed of the metal nano-ink. Thus, both the third layer 60 and the first layer 40 are visible from the front surface side of the dial 10, allowing the dial 10 to express complex, creative, and luxurious design. In particular, since the third layer 60 composed of the dots 61 formed of a metal nano-ink is located on the front surface side of the first layer 40, which is formed of the colored paint containing a pigment, a glossy pattern provided by a pattern of dots 61 is shown against the first layer 40 having a predetermined color, providing the dial 10 with a luxurious look.

The second layer 50 formed of the first resin material is located between the first layer 40 formed of a colored paint containing a pigment and the third layer 60 formed of a metal nano-ink, preventing contact between the colored paint of the first layer 40 and the metal nano-ink of the third layer 60. This can prevent discoloration caused by chemical reaction between the colored paint of the first layer 40 and the metal nano-ink of the third layer 60.

Furthermore, the fourth layer 70 formed of a second resin material is on the surface of the third layer 60, preventing the metal nano-ink of the third layer 60 from being exposed to the air. This prevents discoloration caused by chemical reaction between the metal nano-ink and oxygen and sulfur components in the air.

The third layer 60 is composed of the dots 61 formed by ink jet printing using a metal nano-ink, providing a delicate, highly designed, and luxurious appearance. Furthermore, since the third layer 60 is formed by ink jet printing, the printing pattern of the dots 61 can be readily changed, and thus dials 10 having various designs can be readily produced.

In this embodiment, the base 30 is formed of one of shell, resin, and metal, or a combination of these and thus can have the texture of these materials. In this embodiment, the metal nanoparticles that form the dots 61 of the third layer 60 include one of gold, silver, copper, and platinum and thus can provide a glossy pattern, enabling more luxurious design to be expressed.

### Second Embodiment

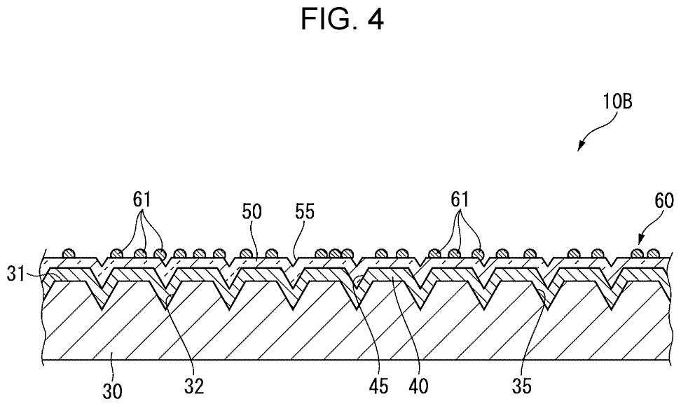

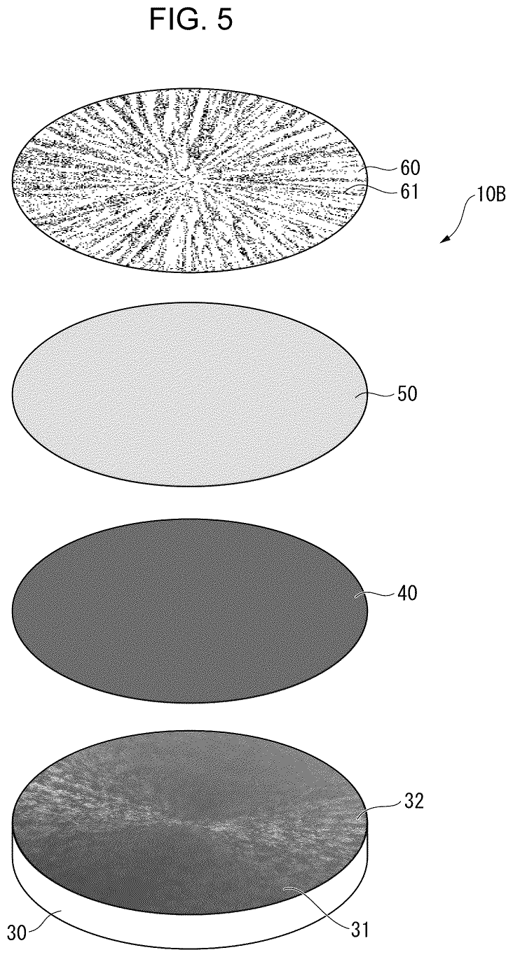

Next, a dial 10B, which is a second embodiment of the watch part, will be described with reference to FIGS. 4 and 5. FIG. 4 is a cross-sectional view of the dial 10B of the second embodiment taken in the thickness direction, and FIG. 5 is an exploded perspective view showing layers of the dial 10B separated from each other. As illustrated in FIG. 4, the dial 10B of the second embodiment includes a base 30, a first layer 40, a second layer 50, and a third layer 60. These components, which have the same configurations as those of the dial 10 of the first embodiment, are assigned the same reference numerals as those of the dial 10 without duplicated explanation. In contrast, the dial 10B does not have the fourth layer 70, and the third layer 60 is the top surface. This is the difference between the dial 10B and the dial 10 of the first embodiment. Since the dial 10B does not have the fourth layer 70, the dots 61 of the third layer 60 are preferably formed of a metal nano-ink that is less likely to be discolored when exposed to the air or the dial 10B is preferably used for an air-tight watch.

The method for producing the dial 10B is the same as the method for producing the dial 10 of the first embodiment. Specifically, as illustrated in FIG. 5, a formation step is performed in which the recesses 32 are formed on the surface 31 of the base 30, for example, by laser processing or die punching to form the bumpy pattern 35. Next, a first step is performed in which a colored paint, which is a decorative material, is applied to the surface 31 of the base 30 to form the first layer 40. Next, a second step is performed in which a first resin material having light-transmitting properties is applied to a surface of the first layer 40 to form the second layer 50. Next, a third step is performed in which ink jet printing using a metal nano-ink is performed on a surface of the second layer 50 based on a prepared printing pattern to form the third layer 60. In short, the dial 10B of this embodiment differs from the dial 10 of the first embodiment in that the method for producing the dial 10B includes the formation step, the first step, the second step, and the third step but does not include the fourth step.

### Advantages of Second Embodiment

The above-described second embodiment can have the same advantages as those of the first embodiment, except for the advantage provided by the fourth layer 70. Furthermore, the dial 10B, which does not have the fourth layer 70, can be produced at a lower cost than the dial 10.

### Modifications

The present disclosure should not be limited to the above-described embodiments and can include modifications, improvements, and the like as long as an object of the present disclosure can be achieved. In the above-described embodiments, the base 30 has the bumpy pattern 35. However, the base 30 should not be limited to this and may have a flat surface without protrusions and recesses or may have a pattern other than the bumpy pattern.

The decorative material forming the first layer should not be limited to the colored paint containing a pigment. For example, the decorative material may be a metal material that is applied to a surface of the base 30 by plating. Alternatively, the decorative material may be an ink that is applied to a surface of the base 30 by ink jet printing. Thus, the method for applying the first layer 40 is not limited to coating and may be, for example, dry plating such as vapor deposition, wet plating, or solid printing by ink jet printing. In other words, an appropriate decorative material forming the first layer 40 and an appropriate method for applying the decorative material can be selected depending on the material of the base 30 and the type of decorative material.

In the above-described embodiments, the watch part of the present disclosure is the dial 10 or 10B, but the present disclosure should not be limited to this. For example, a watch part of the present disclosure may be any one of a case, dial ring, bezel, movement, main plate of the movement, hand, hour mark, and oscillating weight. For example, when used in a skeleton watch that allows the interior to be seen from the back cover side, the watch part of the present disclosure may be a train wheel bridge or an oscillating weight visible from the back cover side. In this case, the surface of the base is a surface on the side from which the watch part is visible, or a surface on the back cover side.

### Summary of Present Disclosure

A watch part according to the present disclosure includes a base, a first layer formed by applying a decorative material to a surface of the base, a second layer formed by applying a first resin material having light-transmitting properties to a surface of the first layer, and a third layer formed by performing ink jet printing using a metal nano-ink containing metal nanoparticles on a surface of the second layer. The watch part of the present disclosure includes, in this order, the first layer formed of a decorative material on a surface of the base, the second layer formed of the first resin material having light transmitting properties, and the third layer formed of dots printed by ink jet printing using a metal nano-ink. This enables not only the third layer but also the first layer to be visible through the second layer from the front surface side of the watch part, and thus complex, creative, and luxurious design can be expressed. Furthermore, the second layer, which is formed of the first resin material and located between the first layer and the third layer prevents contact between a component of the decorative material of the first layer and the metal nanoparticles of the third layer. Thus, discoloration caused by chemical reaction between the decorative material of the first layer and the metal nanoparticles of the third layer can be prevented.

The watch part according to the present disclosure may further include a fourth layer formed by applying a second resin material having light-transmitting properties to a surface of the third layer. The fourth layer formed of a second resin material on the surface of the third layer can prevent the metal nanoparticles of the third layer from being exposed to the air. This can prevent discoloration caused by chemical reaction between the metal nano-ink and oxygen and sulfur components in the air.

In the watch part according to the present disclosure, the first layer may be formed by applying a colored paint to the surface of the base. Since the first layer is formed of the colored paint, the third layer, which is composed of dots formed of a metal nano-ink, can have a different background color from the base, improving the design.

In the watch part according to the present disclosure, the first resin material may be any one of acrylic resin, urethane resin, polyethylene resin, and polyester resin. The use of any one of acrylic resin, urethane resin, polyethylene resin, and polyester resin as the first resin material enables the second layer having light-transmitting properties to be readily and inexpensively formed.

In the watch part according to the present disclosure, the surface of the base may have a bumpy pattern. The bumpy pattern on the surface of the base can provide the pattern including protrusions and recesses, in addition to the pattern provided by the application of the first layer and the printing of the third layer, improving the design.

A watch according to the present disclosure includes the watch part. The watch including the watch part can express complex, creative, and luxurious design and can prevent discoloration caused by chemical reaction between the metal nanoparticles of the third layer and the decorative material of the first layer.

A method for producing a watch part according to the present disclosure includes: applying a decorative material to a surface of a base to form a first layer; applying a first resin material having light-transmitting properties to a surface of the first layer to form a second layer; performing ink jet printing using a metal nano-ink containing metal nanoparticles on a surface of the second layer to form a third layer. According to the present disclosure, the watch part can express complex, creative, and luxurious design and can prevent discoloration caused by chemical reaction between the metal nanoparticles of the third layer and the decorative material of the first layer.

The method for producing a watch part according to the present disclosure may further include applying a second resin material having light-transmitting properties to a surface of the third layer to form a fourth layer. The formation of the fourth layer by applying a second resin material having light-transmitting properties to a surface of the third layer enables the surface of the watch part to be coated with the fourth layer, preventing the metal nanoparticles of the third layer from being exposed to air. This prevents discoloration caused by chemical reaction between the metal nano-ink and oxygen and sulfur components in the air.

In the method for producing a watch part according to the present disclosure, the first layer may be formed by applying a colored paint to the surface of the base. Since the first layer is formed of the colored paint, the third layer, which is composed of dots formed of a metal nano-ink, can have a different background color from the base, improving the design.

The method for producing a watch part according to the present disclosure may further include forming a bumpy pattern on the surface of the base before the first layer is formed. The formation of the bumpy pattern on the surface of the base can provide the pattern including protrusions and recesses, in addition to the pattern provided by the application of the first layer and the printing of the third layer, improving the design.

What is claimed is:

1. A watch part comprising:
a base;
a first layer formed by applying a decorative material to a surface of the base;
a second layer formed by applying a first resin material having light-transmitting properties to a surface of the first layer; and
a third layer formed by performing ink jet printing using a metal nano-ink containing metal nanoparticles on a surface of the second layer.

2. The watch part according to claim 1, further comprising a fourth layer formed by applying a second resin material having light-transmitting properties to a surface of the third layer.

3. The watch part according to claim 1, wherein the first layer is formed by applying a colored paint to the surface of the base.

4. The watch part according to claim 1, wherein the first resin material is any one of acrylic resin, urethane resin, polyethylene resin, and polyester resin.

5. The watch part according to claim 1, wherein the surface of the base has a bumpy pattern.

6. A watch comprising the watch part according to claim 1.

7. A method for producing a watch part comprising:
applying a decorative material to a surface of a base to form a first layer;
applying a first resin material having light-transmitting properties to a surface of the first layer to form a second layer;
performing ink jet printing using a metal nano-ink containing metal nanoparticles on a surface of the second layer to form a third layer.

8. The method for producing a watch part according to claim 7, further comprising applying a second resin material having light-transmitting properties to a surface of the third layer to form a fourth layer.

9. The method for producing a watch part according to claim 7, wherein the first layer is formed by applying a colored paint as the decorative material to the surface of the base.

10. The method for producing a watch part according to claim 7, further comprising forming a bumpy pattern on the surface of the base before the first layer is formed.
